(19) United States
(12) Patent Application Publication
(10) Pub. No.: US 2019/0001240 A1
(43) Pub. Date: Jan. 3, 2019

(54) FILTRATION DEVICE

(71) Applicant: NITTA HAAS INCORPORATED, Osaka (JP)

(72) Inventors: Katsumi KAWASE, Mie (JP); Yoshitane Shigeta, Kyoto (JP); Masahito Yamakoshi, Mie (JP)

(21) Appl. No.: 15/742,932

(22) PCT Filed: Jul. 8, 2016
(86) PCT No.: PCT/JP2016/070296

§ 371 Date: Jan. 9, 2018

(30) Foreign Application Priority Data
Jul. 10, 2015 (JP) 2015-138947

(51) Int. Cl. B01D 29/05; B01D 29/56; B01D 35/18; B01D 39/18

(52) U.S. Cl. CPC B01D 29/05; B01D 39/18; B01D 35/18; B01D 29/56

(57) ABSTRACT

Provided is a filtration device including: a filter unit having a filter medium; and a holder configured to hold the filter unit and form a flow path in which a fluid passes through the filter medium of the filter unit, wherein a pore size of the filter medium at the downstream end position of the filter unit is smaller than a pore size of the filter medium at the upstream end position of the filter unit.

### CROSS-REFERENCE TO RELATED APPLICATION

This application claims priority to Japanese Patent Application No. 2015-138947, the disclosure of which is incorporated herein by reference in its entirety.

### FIELD

The present invention relates to a filtration device configured to remove solid matter contained in a fluid from the fluid.

### BACKGROUND

Conventionally, filtration devices configured to filter a fluid containing solid matter are known (see Patent Literature 1). Such a filtration device includes a filter (filter medium) and a container that has the filter arranged therein and forms a flow path in which the fluid passes through the filter. The filter has a specific pore size so as to be capable of capturing a filtration target (solid matter to be removed from the fluid by the filter) contained in the fluid, when the fluid passes through the filter, or preventing the pass-through.

The filtration device filters the fluid by supplying the fluid into the container and allowing it to pass through the filter (that is, it removes the filtration target contained in the fluid from the fluid).

### CITATION LIST

### Patent Literature

Patent Literature 1: JP 2008-128991 A

### SUMMARY

### Technical Problem

However, in the filter of the aforementioned filtration device, capture or the like of the filtration target takes place mainly at a site on the upstream end side of the filter when the fluid passes through the filter, and therefore the filter clogs, even if the filtration performance at a site on the downstream end side sufficiently remains, so that the filter needs to be replaced.

Therefore, recently in such a filtration device, there is a demand for enabling long-term use of the filter by suppressing the clogging or the like of the filter while maintaining the filtration accuracy, that is, there is a demand for improving the filtration performance.

It is therefore an object of the present invention to provide a filtration device with improved filtration performance.

### Solution to Problem

A filtration device according to the present invention includes: a filter unit having a filter medium; and a holder configured to hold the filter unit and form a flow path in which a fluid passes through the filter medium of the filter unit, wherein a pore size of the filter medium at the downstream end position of the filter unit is smaller than a pore size of the filter medium at the upstream end position of the filter unit.

Further, in the filtration device, it is preferable that the filter unit include: a plurality of filter media as described above which are stacked in a circulation direction of the fluid, and the plurality of filter media each have a different pore size.

Further, in the filtration device, it is preferable that the larger the pore size of the filter media, the larger the dimension in the circulation direction of the filter media.

In the filtration device, the filter media may be filter paper.

### BRIEF DESCRIPTION OF DRAWINGS

FIG. 1 is a schematic view of a polishing pad material purification system according to the present embodiment.

FIG. 2 is a perspective view of a filtration device in the material purification system.

FIG. 3 is a perspective view showing the state where a cover unit of the filtration device is opened.

FIG. 4 is a vertical sectional view of the filtration device.

FIG. 5 is a view for explaining a configuration of a filter unit of the filtration device.

### DESCRIPTION OF EMBODIMENTS

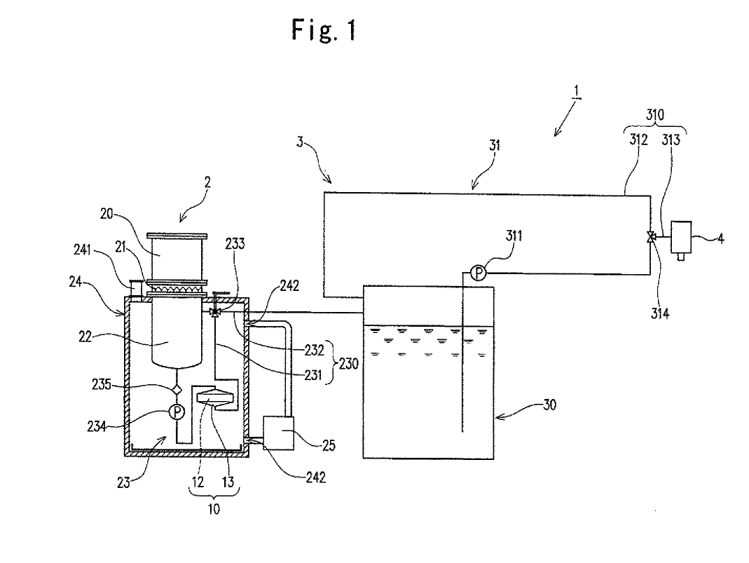

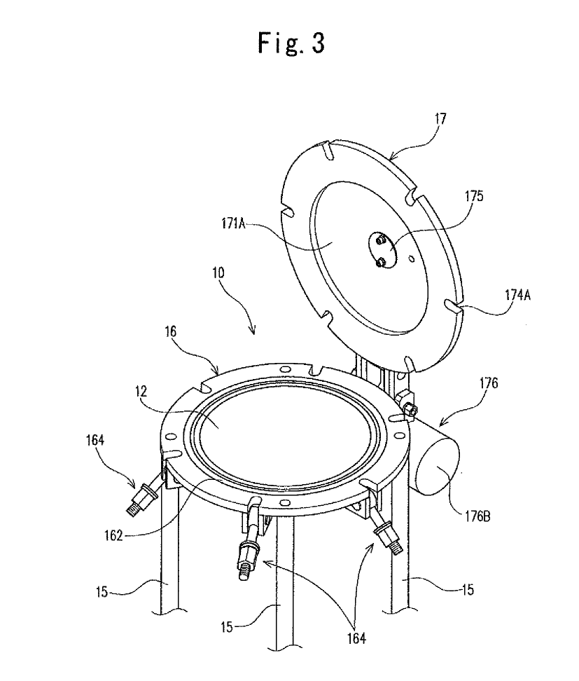

Hereinafter, an embodiment of the present invention will be described with reference to FIG. 1 to FIG. 5.

The filtration device of this embodiment can filter a fluid such as a liquid by passing it therethrough to remove or capture solid matter contained in the fluid. The filtration device is used by being installed, for example, in a material purification system configured to purify a material for producing polishing pads (which will be hereinafter referred to as “material purification system”).

Such a material purification system purifies a liquid material by melting a solid material. Specifically, as shown in FIG. 1, the material purification system includes a melting device 2 configured to melt the solid material put therein, a homogenizer 3 configured to homogenize the material (liquid material) melted by the melting device 2, and an outlet device 4 configured to output the liquid material homogenized by the homogenizer 3 to the outside of the material system 1. Hereinafter, a material in solid state may be referred to as a solid material, and the material obtained by melting the solid material to change it from solid state to liquid state may be referred to as a liquid material, in some cases. The solid material of this embodiment is, for example, 4,4′-methylenebis(o-chloroaniline) (so-called MOCA) in pellet form. The solid material is heat-meltable.

The melting device 2 includes an inlet 20 into which the solid material is put, a melting unit 21 configured to melt the solid material put into the inlet 20, a storage 22 configured to store the material (liquid material) melted by the melting unit 21, and a first circulation system 23 configured to circulate the liquid material stored in the storage 22.

The inlet 20 stores the solid material (in an example of this embodiment, MOCA in pellet form) put from the outside and supplies the stored solid material to the melting unit 21. The melting unit 21 melts the solid material (that is, changes it from solid state to liquid state) by heating the solid material supplied from the inlet 20. The storage 22 is arranged below the melting unit 21 and stores the liquid material (liquid matter obtained by melting the solid material) flowing down from the melting unit 21.

The first circulation system 23 includes a first flow path 230 that is connected to the storage 22 and allows the liquid material to be circulated therethrough, a first pump 234 configured to circulate the liquid material through the first flow path 230, a strainer 235 configured to prevent the inflow of solid matter into the first pump 234, and a filtration device 10 configured to filter the liquid material.

The first flow path 230 includes a first circulation flow pipe 231 with both ends connected to the storage 22, a first connection pipe 232 configured to connect the first circulation flow pipe 231 (specifically, an intermediate position of the first circulation flow pipe 231) and the homogenizer 3 to each other, and a first switching valve 233 arranged at the branching position of the first connection pipe 232 from the first circulation flow pipe 231.

One end of the first circulation flow pipe 231 is connected to the lower end of the storage 22, and the other end thereof is connected to an upper part of the storage 22. Thereby, the first circulation flow pipe 231 forms a circulation flow path of the liquid material through which the liquid material stored in the storage 22 passes through the first circulation flow pipe 231 and is returned to the storage 22 again. The first switching valve 233 switches the direction of the flow of the liquid material flowing into the first switching valve 233 in the first flow path 230 toward the storage 22 or toward the first connection pipe 232.

The first pump 234 is arranged at an upstream position of the first switching valve 233 in the first circulation flow pipe 231 and is configured to cause the liquid material stored in the storage 22 to flow into the first circulation flow pipe 231. Specifically, the first pump 234 suctions the liquid material stored in the storage 22 from the one end (the end connected to the lower end of the storage 22) side of the first circulation flow pipe 231 into the first circulation flow pipe 231. The first pump 234 of this embodiment is, for example, a gear pump. The first pump 234 is not limited to the gear pump. The first pump 234 needs only to be a pump capable of circulating the liquid material stored in the storage 22 through the first circulation system 23.

The strainer 235 is arranged at an upstream position of the first pump 234 in the first circulation flow pipe 231 and prevents solid matter (solid matter with a size that can cause malfunction of the first pump 234 when it is supplied to the first pump 234) contained in the liquid material circulated through the first circulation flow pipe 231 from flowing toward the first pump 234. The strainer 235 is constituted by a mesh made of metal, a perforated metal, or the like.

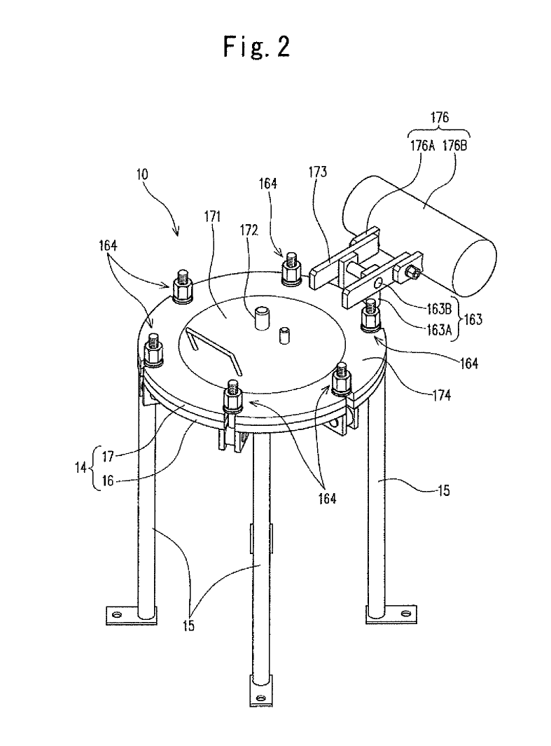

The filtration device 10 is arranged between the first pump 234 and the first switching valve 233 in the first circulation flow pipe 231. As shown also in FIG. 2 to FIG. 5, the filtration device 10 includes a filter unit 12 having filter media 11, and a holder 13 configured to hold the filter unit 12 and form a flow path (internal flow path) in which the fluid (the liquid material in an example of this embodiment) passes through the filter media 11 of the filter unit 12. In the filter unit 12 of this embodiment, the pore size of the filter medium 11 at the downstream end position in the circulation direction of the liquid material (which will be hereinafter referred to simply as “circulation direction”) in the internal flow path is smaller than the pore size of the filter medium 11 at the upstream end position. The specific configuration of the filtration device 10 is as follows.

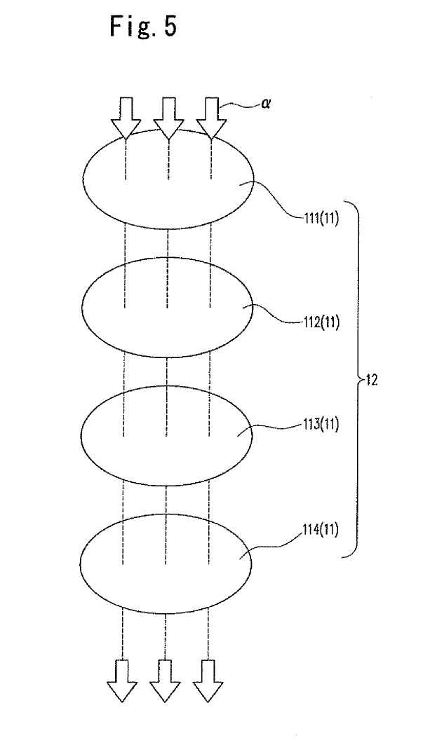

The filter unit 12 includes a plurality of filter media 11 stacked in the circulation direction (see the arrows a in FIG. 5). The filter media 11 of this embodiment are filter paper, and four sheets of filter paper 11 are layered in the circulation direction in the filter unit 12 of this embodiment. At least one of the four sheets of filter paper 11 has a different pore size from the other sheets. The larger the pore size of the filter paper 11, the larger the thickness (the dimension in the circulation direction) of the filter paper 11.

Specifically, in the filter unit 12 of this embodiment, a first filter paper 111, a second filter paper 112, a third filter paper 113, and a fourth filter paper 114 are layered sequentially from the upstream side. The pore size of the first filter paper 111 is 1 μm, and the pore size of each of the second filter paper 112 to the fourth filter paper 114 is 0.5 μm. The contour of each filter paper (the first filter paper 111 to the fourth filter paper 114) is circular, and the diameter thereof is about 300 mm. The thickness of the first filter paper 111 is 3 mm, and the thickness of each of the second filter paper 112 to the fourth filter paper 114 is 0.6 mm.

The holder 13 includes a holder body 14 configured to house the filter unit 12 thereinside and support legs 15 configured to support the holder body 14.

The holder body 14 has a flow path (internal flow path) that is connected to the first circulation flow pipe 231 and allows the liquid material to flow therethrough. The holder body 14 has a bottom unit 16 covering the lower side (one side in the circulation direction) of the filter unit 12, a cover unit 17 openably covering the filter unit 12 from the upper side (the other side in the circulation direction), and a filter support 18 arranged on the bottom unit 16 and configured to support the filter unit 12 (the filter media 11) from below. In the holder body 14 of this embodiment, the liquid material flows into the internal flow path from the cover unit 17 side, passes through the filter unit, and thereafter flows out from the bottom unit 16 side.

The bottom unit 16 has a recess 160 recessed downward (that is, open upward) at its upper end, and a discharge part 161 configured to allow communication between the space inside the recess 160 and the outside. The bottom unit 16 includes a seal member 162 in the form of a ring surrounding the circumference of the recess 160. The seal member 162 is located between the bottom unit 16 and the cover unit 17 when the cover unit 17 is closed so as to ensure the liquid tightness between the bottom unit 16 and the cover unit 17. The bottom unit 16 of this embodiment is a disk-shaped member expanding in the horizontal direction, and the recess 160 is recessed into a circular shape that is concentric with the bottom unit 16 in planer view. The bottom surface of the recess 160 is a flat surface that is circular in planer view, and the discharge part 161 is connected to the center of the bottom surface of the recess 160. The discharge part 161 is connected to the first circulation flow pipe 231.

The bottom unit 16 includes a bottom-side connector 163 to which the cover unit 17 is pivotally connected. The bottom-side connector 163 has a support part 163A extending from the circumferential edge of the bottom unit 16, and a center shaft 163B extending in a direction orthogonal to the radial direction of the bottom unit 16 at the distal end of the support part 163A.

The bottom unit 16 has at least one cover fixing unit 164 configured to fix the cover unit 17 in the closed state to the bottom unit 16. The bottom unit 16 of this embodiment includes a plurality (six in an example of this embodiment) of cover fixing units 164 at intervals in the circumferential direction. Each of the cover fixing units 164 of this embodiment includes a pivot member 165 extending in a specific direction and configured to pivot, with one end serving as the pivotal center and the circumferential surface of the other end being externally threaded, and a tightening member 166 configured to be threadedly engaged with the other end of the pivot member 165.

The one end of the pivot member 165 pivots about a center shaft 167 serving as the pivotal center and provided on the lower surface side of the circumferential edge at a specific position in the circumferential direction of the bottom unit 16. The center shaft 167 extends in a direction orthogonal to the diameter direction of the bottom unit 16 that passes through the center in the length direction of the center shaft 167.

The tightening member 166 moves toward and away from the center shaft 167 by being rotated about the axis of the pivot member 165 while being threadedly engaged with the other end of the pivot member 165.

The cover unit 17 in the closed state forms an internal flow path, in which the liquid material passes through the first filter paper 111 to the fourth filter paper 114 of the filter unit 12 in the thickness direction, in cooperation with the bottom unit 16. Specifically, the cover unit 17 includes a cover body 171 having a concave 171A that is concave upward, an inflow part 172 that allows communication between the space inside the concave 171A of the cover body 171 and the outside, a cover-side connector 173 configured to be pivotally engaged with the bottom-side connector 163, and a flange 174 expanding in the horizontal direction from the circumferential edge of the cover body 171.

The concave 171A has a size corresponding to the recess 160 of the bottom unit 16 (in an example of this embodiment, a dimension slightly larger than the diameter of the recess 160 of the bottom unit 16) in planer view. The concave 171A of this embodiment has a spherical inner surface. The inflow part 172 is connected to the center on the inner surface of the concave 171A. The inflow part 172 is connected to the first circulation flow pipe 231. The cover body 171 of this embodiment is constituted by a member having a substantially constant thickness. Therefore, the cover body 171 is formed into an upwardly bulging dome shape.

The cover-side connector 173 extends in the radial direction from a position of the flange 174 corresponding to the bottom-side connector 163 and is engaged with the center shaft 163B so as to be pivotable about the center shaft 163B of the bottom-side connector 163. Thereby, the cover unit 17 can pivot about the center shaft 163B of the bottom-side connector 163 as the pivotal center so as to be opened and closed with respect to the bottom unit 16.

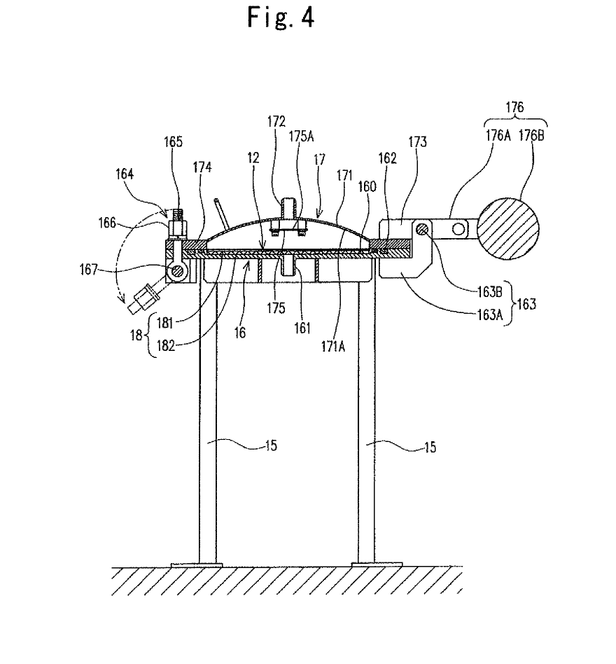

The flange 174 has notches 174A recessed inwardly in the horizontal direction at the respective positions corresponding to the plurality of cover fixing units 164 of the bottom unit 16 in the circumferential direction. In each of the cover fixing units 164, the tightening member 166 is moved toward the bottom unit 16 side (the center shaft 167 side) by being rotated, while the pivot member 165 of the cover fixing unit 164 is fitted in each notch 174A, thereby allowing the flange 174 to be firmly sandwiched by the bottom unit 16 and the tightening member 166, so that the cover unit 17 is fixed to the bottom unit 16 in the closed state (see FIG. 2 and FIG. 4). Whilst, when the cover unit 17 is opened, the cover unit 17 in the closed and fixed state is moved by rotating the tightening member 166 toward the opposite direction of the bottom unit 16, and subsequently the pivot member 165 is pivoted to be detached from the notch 174A of the cover unit 17, in each of the cover fixing unit 164 (see the portion shown by the dashed-double-dotted line with the reference numeral 165 in FIG. 4). Thereby, the cover unit 17 is rendered pivotable about the center shaft 163B of the bottom-side connector 163, so that the cover unit 17 can be opened (pivoted about the center shaft 163B as the pivotal center).

The cover unit 17 includes a sprinkling member 175 configured to make the flow of the liquid material circulated through the internal flow path that is defined by the bottom unit 16 and the cover unit 17 uniform, and an opening and closing assisting unit 176 configured to assist the opening and closing of the cover unit 17.

The sprinkling member 175 is arranged inside the concave 171A of the cover unit 17 and is configured to distribute, in the horizontal direction, the flow of the liquid material flowing from the inflow part 172 into the concave 171A. Specifically, the sprinkling member 175 has a facing surface 175A expanding in the horizontal direction at the top and is arranged at the position where the facing surface 175A is opposed to the connected position of the inflow part 172 (the position where the liquid material flows from the inflow part 172 into the concave 171A) at an interval. When the liquid material flowing from the inflow part 172 into the concave 171A collides with the facing surface 175A of the sprinkling member 175, the flow of the liquid material is distributed in the horizontal direction. Thereby, the non-uniformity in the horizon plane direction of the flow rate of the liquid material flowing downward through the space (internal flow path) defined by the cover unit 17 and the bottom unit 16 is suppressed.

The opening and closing assisting unit 176 has an extended part 176A extending from the cover-side connector 173 to a position over the center shaft 163B of the bottom-side connector 163, and a weight 176B arranged at the distal end of the extended part 176A. Such arrangement of the weight 176E at a position on the opposite side of the cover body 171 with the center shaft 163B of the bottom-side connector 163 interposed therebetween can reduce the power required for opening and closing the cover unit 17, as compared with the case where the opening and closing assisting unit 176 is not provided.

The filter support 18 supports the filter unit 12 (in an example of this embodiment, the first filter paper 111, the second filter paper 112, the third filter paper 113, and the fourth filter paper 114, which are layered) from below while allowing the liquid material to pass therethrough downwardly from above. The filter support 18 of this embodiment has a perforated plate 181 expanding in the horizontal direction, and a spacing member 182 configured to form a specific space between the perforated plate 181 and the bottom surface of the recess 160 of the bottom unit 16.

The filter unit 12 (the first filter paper 111, the second filter paper 112, the third filter paper 113, and the fourth filter paper 114 in the layered state) supported by the filter support 18 configured as above is fixed inside the holder body 14 by the circumferential edge of the filter unit 12 (the first filter paper 111, the second filter paper 112, the third filter paper 113, and the fourth filter paper 114 in the layered state) being sandwiched between the bottom unit 16 and the cover unit 17.

Returning to FIG. 1, the melting device 2 includes a housing 24 configured to house the storage 22 and the first circulation flow pipe 231 thereinside, and a heat retaining unit 25 configured to maintain the temperature inside the housing 24 at a specific temperature (a temperature at which the liquid material does not solidify). The housing 24 has a discharge port 241 capable of discharging internal gases to the outside, and a connection port 242 to which the heat retaining unit 25 is connected. The heat retaining unit 25 supplies hot air into the housing 24 through the connection port 242. The temperature inside the housing 24 is maintained at a specific temperature (in an example of this embodiment, 120° C.) by the hot air sent from the heat retaining unit 25 into the housing 24 through the connection port 242. This can prevent the liquid material stored in the storage 22 and the liquid material circulated through the first circulation flow pipe 231 from being cooled to solidify in the melting device 2.

The homogenizer 3 has a reservoir 30 configured to store the liquid material supplied from the melting device 2 through the first connection pipe 232, and a second circulation system 31 configured to circulate the liquid material stored in the reservoir 30.

The second circulation system 31 has a second flow path 310 that is connected to the reservoir 30 and allows the liquid material to be circulated therethrough, and a second pump 311 configured to circulate the liquid material through the second flow path 310.

The second flow path 310 has a second circulation flow pipe 312 with both ends connected to the reservoir 30, a second connection pipe 313 configured to connect the second circulation flow pipe 312 (specifically, an intermediate position of the second circulation flow pipe 312) and the outlet device 4 to each other, and a second switching valve 314 arranged at a branching position of the second connection pipe 313 from the second circulation flow pipe 312.

One end of the second circulation flow pipe 312 is arranged in the vicinity of the bottom surface inside the reservoir 30, and the other end thereof is connected to an upper part of the reservoir 30. Thereby, the second circulation flow pipe 312 forms a circulation flow path of the liquid material through which the liquid material stored in the reservoir 30 passes through the second circulation flow pipe 312 and returns again to the reservoir 30. The second switching valve 314 switches the direction of the flow of the liquid material flowing into the second switching valve 314 toward the reservoir 30 or toward the second connection pipe 313, in the second flow path 310.

The second pump 311 is connected to an intermediate position of the second circulation flow pipe 312 (in an example of this embodiment, an upper position of the reservoir 30 outside the reservoir 30) and allows the liquid material stored in the reservoir 30 to flow into the second circulation flow pipe 312.

In the homogenizer 3 configured as above, the processing amount of the material that can be homogenized (the amount of the liquid material that can be circulated) is larger than the processing amount of the material that can be subjected to melting or the like in the melting device 2 (the amount of the liquid material that can be circulated).

The outlet device 4 is connected to the second flow path 310 (specifically, the second connection pipe 313) of the homogenizer 3 and outputs the liquid material supplied from the second flow path 310 to the outside of the second circulation system 31. The outlet device 4, for example, may be configured to be supplied with one or a plurality of materials other than the liquid material supplied from the homogenizer 3, in addition to the liquid material, and to output the plurality of materials (including the liquid material supplied from the homogenizer 3) through one outlet port.

The material purification system 1 of this embodiment is configured as described above. Hereinafter, the operation of the material purification system 1 will be described.

First, a solid material is put into the inlet 20 of the melting device 2. In this embodiment, the solid material is put into the inlet 20 in batches. When the solid material put into the inlet 20 is supplied to the melting unit 21, the melting unit 21 melts the solid material supplied therein. The melted solid material (that is, liquid material) flows into the storage 22 and is stored therein, and when a specific amount of the liquid material is accumulated in the storage 22, the first pump 234 is actuated to start the circulation of the liquid material stored in the storage 22 through the first circulation flow pipe 231. At this time, since the first switching valve 233 has been switched so that the liquid material flowing into the first switching valve 233 flows toward the storage 22, the liquid material is circulated between the storage 22 and the first circulation flow pipe 231. The heat retaining unit 25 is actuated to maintain the temperature inside the housing 24 at a specific temperature (the temperature at which the liquid material does not solidify: 120° C., in an example of this embodiment).

The liquid material that has started being circulated through the first circulation flow pipe 231 passes through the strainer 235 and thereafter passes through the filtration device 10. Specifically, the liquid material passes through the filter unit 12 (specifically, a plurality of layered sheets of the filter paper 11 (the first filter paper 111, the second filter paper 112, the third filter paper 113, and the fourth filter paper 114)) by flowing through the internal flow path formed in the holder 13, in the filtration device 10. At this time, solid matter contained in the liquid material (such as foreign matter and a solid material that have failed to be melted in the melting unit) is captured by the filter unit 12 and is separated (filtered out) from the liquid material.

The liquid material that has passed through the filtration device 10 returns again to the storage 22 and is continuously circulated between the storage 22 and the first circulation flow pipe 231. By such circulation, the liquid material is stirred, and the liquid material stored in the storage 22 is homogenized. The circulation allows the same liquid material to pass through the filtration device 10 multiple times, so that the solid matter is removed from the liquid material more reliably. A part of the solid matter caught by the filter unit 12 (the solid material that has failed to be melted in the melting unit 21) is gradually melted by the circulation of the liquid material that is maintained at high temperature (in an example of this embodiment, about 120° C.) by maintaining the temperature inside the housing 24 at a specific temperature (in an example of this embodiment, 120° C.).

After the solid material put into the inlet 20 (one batch of solid material) has been fully melted by the melting unit 21, and the removal of the solid matter contained in the liquid material stored in the storage 22 by the circulation between the storage 22 and the first circulation flow pipe 231 and the homogenization of the liquid material by the circulation are completed, the first switching valve 233 is switched. Thereby, the liquid material circulated between the storage 22 and the first circulation flow pipe 231 is supplied to the homogenizer 3 through the first connection pipe 232.

In the homogenizer 3, the liquid material supplied from the first connection pipe 232 is stored in the reservoir 30. The liquid material stored in the reservoir 30 is circulated between the reservoir 30 and the second circulation flow pipe 312 by actuating the second pump 311 while the second switching valve 314 is switched so that the liquid material flowing into the second switching valve 314 flows toward the reservoir 30. As described above, the processing amount of the material that can be homogenized in the homogenizer 3 (the amount of the liquid material that can be circulated in the homogenizer 3, that is, the amount equivalent to several batches of solid material put into the inlet 20) is larger than the processing amount of the material that can be subjected to melting or the like in the melting device 2 (the amount of the liquid material that can be circulated in the melting device 2, that is, the amount equivalent to one batch of solid material put into the inlet). Therefore, the solid material melted in the melting device 2 (liquid material) is sent out to the reservoir 30 of the homogenizer 3 and is then circulated between the reservoir 30 and the second circulation flow pipe 312 together with the liquid material supplied earlier from the melting device 2 to the homogenizer 3 (the material melted earlier). Thereby, the material melted earlier and the material melted later are stirred to be mixed together in the homogenizer 3, as a result of which the liquid material is further homogenized.

After the liquid material is sufficiently homogenized in the homogenizer 3, the second switching valve 314 is switched, and the circulated liquid material is output from the outlet device 4 to the outside of the second circulation system 31 as a material for polishing pads.

In the filtration device 10 of the aforementioned material purification system 1, the pore size of the filter medium 11 at the downstream end position of the filter unit 12 (the fourth filter paper 114) is smaller than the pore size of the filter medium 11 at the upstream end position of the filter unit 12 (the first filter paper 111). According to such a configuration, large solid matter (filtration target) can be captured at a site on the upstream end side of the filter unit 12, and small solid matter can be captured at a site on the downstream end side, that is, solid matter can be captured in the entire area of the filter unit 12 in this direction. Thereby, long-term use can be enabled (that is, the filtration performance can be improved) by suppressing clogging while maintaining the filtration performance, as compared with the case where capture or the like of solid matter takes place mainly at a site on the upstream end side in the circulation direction.

In the filtration device 10 of this embodiment, the filter unit 12 has the plurality of filter media 11 (in an example of this embodiment, the first filter paper 111, the second filter paper 112, the third filter paper 113, and the fourth filter paper 114) that are stacked in the circulation direction of the fluid and have different pore sizes. Therefore, replacement of a part of the filter unit 12 (the filter medium 11 arranged at a corresponding position) in the circulation direction is enabled. This enables the replacement of the filter medium 11 only in the part of the filter unit 12 where clogging has occurred (the clogged portion) in the circulation direction and further enables the change of the pore size of a part of the filter unit 12 in the circulation direction.

In the filtration device 10 of this embodiment, the first filter paper 111 to the fourth filter paper 114 have dimensions in the circulation direction of the liquid material (thickness dimensions) that increase from the first filter paper 111 that has a large pore size, to the second filter paper 112, the third filter paper 113, and the fourth filter paper 114, in this order. In this way, in the first filter paper 111, the second filter paper 112, the third filter paper 113, and the fourth filter paper 114, the larger the pore size, the larger the thickness dimension, that is, solid matter that is slightly larger than the pore size can be captured more reliably by increasing the distance necessary to pass through the first filter paper 111 to the fourth filter paper 114.

The filter paper is more resistant to heat than filter medium made of resin such as PTFE. Therefore, a high-temperature fluid can be filtered in the filtration device 10 of this embodiment. Moreover, specific rigidity can be ensured in the filter unit 12 by stacking the plurality of sheets of filter paper (the first filter paper 111, the second filter paper 112, the third filter paper 113, and the fourth filter paper 114), even if the filter paper having small rigidity when used as one sheet is used.

The filtration device of the present invention is not limited to the aforementioned embodiment, and it is, of course, that various modifications can be made without departing from the gist of the present invention. For example, a configuration of another embodiment can be added to a configuration of an embodiment, and further a part of a configuration of an embodiment can be replaced with a configuration of another embodiment. Further, a part of a configuration of an embodiment can be deleted.

In the filtration device 10 of the aforementioned embodiment, the filter unit 12 is constituted only by the filter media 11 (in an example of the aforementioned embodiment, the first filter paper 111, the second filter paper 112, the third filter paper 113, and the fourth filter paper 114), but there is no limitation to this configuration. For example, the filter unit 12 may be constituted by the plurality of filter media 11 and a fixing member (such as a holder) configured to suppress the displacement of relative positions of the filter media 11 from each other.

In the filtration device 10 of the aforementioned embodiment, the filter unit. 12 has the four filter media 11 (in an example of the aforementioned embodiment, the first filter paper 111, the second filter paper 112, the third filter paper 113, and the fourth filter paper 114) that are stacked, but the filter unit 12 may have one filter medium 11 or two to three or five or more filter media 11 that are stacked. In the case where the filter unit 12 is constituted by one filter medium 11, the filter medium 11 is formed to have a smaller pore size at the downstream end position than the pore size at the upstream end position, that is, the filter medium 11 is formed so that the pore size at the upstream end position is different from the pore size at the downstream end position.

In the filtration device 10 of the aforementioned embodiment, the filter media 11 having two types of pore sizes are arranged in the filter unit 12, but there is no limitation to this configuration. For example, the filter media 11 arranged in the filter unit 12 may have three types or more of pore sizes. Further, the filter unit 12 may be configured to have pore sizes decreasing in each filter medium from upstream to downstream. That is, the plurality of filter media 11 need only to be configured so that the pore size of the filter medium 11 arranged at the downstream end position is smaller than the pore size of the filter medium 11 arranged at the upstream end position, and in two filter media 11 that are adjacent to each other in the direction in which the fluid passes therethrough, the pore size of the filter medium 11 on the downstream side is the same as or smaller than the pore size of the filter medium 11 on the upstream side.

In the filtration device 10 of the aforementioned embodiment, the larger the pore size of the filter media 11, the larger the thickness dimension (dimension in the direction in which the fluid passes therethrough), but there is no limitation to this configuration. In the plurality of filter media 11 arranged in the filter unit 12, the thickness dimensions of the filter media 11 may be the same. In this case, it is preferable that the thickness dimension of the filter medium 11 having small pore size be adjusted to a thickness dimension such that the filtration performance is sufficiently ensured in the filter medium 11 having a large pore size.

The specific configuration of the holder 13 is not limited. The holder 13 needs only to be configured so as to hold the filter unit 12 thereinside and form the internal flow path in which the supplied fluid passes through the filter unit 12.

In the filtration device 10 of the aforementioned embodiment, the filter media 11 are filter paper, but there is no limitation to this configuration. The filter media 11 may be constituted by non-woven fabrics or fabrics.

### REFERENCE SIGNS LIST

1: Material system
2: Melting device
20: Inlet
21: Melting unit
22: Storage
23: First circulation system
230: First flow path
231: First circulation flow pipe
232: First connection pipe
233: First switching valve
234: First pump
235: Strainer
24: Housing
241: Discharge port
242: Connection port
25: Heat retaining unit
3: Homogenizer
30: Reservoir
31: Second circulation system
310: Second flow path
311: Second pump
312: Second circulation flow pipe
313: Second connection pipe
314: Second switching valve
4: Outlet device
10: Filtration device
11: Filter medium (Filter paper)
111: First filter paper
112: Second filter paper
113: Third filter paper
114: Fourth filter paper
12: Filter unit
13: Holder
14: Holder body
15: Support leg
16: Bottom unit
160: Recess
161: Discharge part
162: Seal member
163: Bottom-side connector
163A: Support part
163B: Center shaft
164: Cover fixing unit
165: Pivot member
166: Tightening member
167: Center shaft
17: Cover unit
171: Cover body
171A: Concave
172: Inflow part
173: Cover-side connector
174: Flange
174A: Notch
175: Sprinkling member
175A: Facing surface
176: Opening and closing assisting unit
176A: Extended part
176B: Weight
18: Filter support
181: Perforated plate
182: Spacing member

1. A filtration device comprising:
a filter unit having a filter medium; and
a holder configured to hold the filter unit and form a flow path in which a fluid passes through the filter medium of the filter unit, wherein
a pore size of the filter medium at the downstream end position of the filter unit is smaller than a pore size of the filter medium at the upstream end position of the filter unit.

2. The filtration device according to claim 1, wherein
the filter unit comprises: a plurality of filter media as set forth which are stacked in a circulation direction of the fluid, and
the plurality of filter media each have a different pore size.

3. The filtration device according to claim 2, wherein
the larger the pore size of the filter media, the larger the dimension in the circulation direction of the filter media.

4. The filtration device according to claim 2, wherein
the filter media are filter paper.
